(19) United States
(12) Patent Application Publication
(10) Pub. No.: US 2025/0145854 A1
(43) Pub. Date: May 8, 2025

(54) REDUCED VISCOSITY COMPOSITIONS CONTAINING POLYAMIDEIMIDE POLYMERS

(71) Applicant: Solvay Specialty Polymers USA, LLC, Alpharetta, GA (US)

(72) Inventors: R. William TILFORD, Stone Mountain, GA (US); Jarrod PELLISSIER, Alpharetta, GA (US); Sophie GALINAT DELPEH, Pessac Cedex (FR); Samantha ARMISEN, Pessac Cedex (FR); Anthony BOCAHUT, Milano (IT)

(21) Appl. No.: 18/681,354

(22) PCT Filed: Aug. 22, 2022
(86) PCT No.: PCT/EP2022/073318

§ 371 Date: Feb. 5, 2024

(30) Foreign Application Priority Data
Aug. 26, 2021 (EP) 21306153.4

(51) Int. Cl. C09D 179/08; C08G 73/14; C09D 7/20

(52) U.S. Cl. CPC C09D 179/08; C08G 73/14; C09D 7/20

(57) ABSTRACT

Compositions based on low toxicity solvents, in particular coating formulations, having reduced viscosity are disclosed. The compositions contain polyamideimide polymers having well-defined molecular weight distribution.

This application claims priority from European patent application Nr 21306153.4 filed on 26 Aug. 2021, the whole content of this application being incorporated herein by reference for all purposes.

### TECHNICAL FIELD

The present invention relates to formulations, in particular coating formulations, containing polyamideimide polymers and low toxicity solvents having reduced viscosity and to the polyamideimide polymers for the preparation of the same.

### BACKGROUND ART

Polyamideimide and polyamic acid polymers (hereinafter collectively referred to as PAI) are well-known, thermally stable polymers that are used for many high performance coating applications due to their excellent adhesion, temperature resistance, and high strength. PAI is commonly utilized as a protective coating for metal substrates subjected to harsh environments, including temperature, wear, abrasion, and chemical exposure.

Typically, a polar aprotic solvent, generally a N-methyl amide type of solvent, in particular N-methyl pyrrolidone (NMP), is employed to dissolve the polymer to prepare coating compositions. Once applied onto a substrate the composition is subjected to a thermal cure process that removes the solvent and builds molecular weight in order to achieve the optimum desired properties of the material. A critical drawback to this approach is that NMP is known to be toxic. There is thus a need to find suitable other solvents. Alternate solvents such as tetrahydrofuran, methyl ethyl ketone, gamma-butyrolactone, or dimethyl sulfoxide have drawbacks such as low polymer solubility or poor storage stability, which may change the polymer properties and application performance of the polymer as well as other practical considerations.

Biodegradable and less hazardous alternatives to solvents like NMP are available, such as NBP (N-n-butyl-2-pyrrolidone), marketed under the trade name Tamisolv® NxG by Eastman or methyl-5-(dimethylamino)-2-methyl-5-oxopentanoate marketed under the Rhodiasolv® PolarClean trade name by Solvay. The primary challenge in implementing the use of these alternative solvents is that, while in some cases they may succeed in producing homogenous solutions of polymer, they tend to have poorer solvency resulting in higher viscosity, which is generally unsuitable for coating applications.

WO2015/161107 A1 and WO2015/161131 A1 (FUJIFILM HOLDINGS CORP.) try to address the issue. These documents disclose a method for manufacturing PAI resins, via the isocyanate route, using a solvent and co-solvent mixture and also PAI-containing coating compositions comprising a PAI resin in a solvent and co-solvent mixture. The solvent and co-solvent mixture comprises at least one aprotic dialkylamide solvent and at least one co-solvent selected from a group consisting of methyl acetate, n-propyl acetate, t-butyl acetate, iso-butyl acetate, ethyl acetate, isopropyl acetate, methyl lactate, ethyl lactate, n-propyl lactate, isopropyl lactate, n-butyl lactate, isobutyl lactate, t-butyl lactate, cyclohexanone, cyclopentanone, n-butyl acetate, methyl alcohol, ethyl alcohol, isopropyl alcohol, n-acetyl morpholine, e-caprolactone and methylcyclohexane.

While the coating compositions disclosed in WO2015/161107 A1 and WO2015/161131 A1 are characterised by suitable viscosity they require the use of solvent mixtures with increased complexity in the handling of the same at industrial level.

It has now been surprisingly found that by controlling the molecular weight distribution of the polyamic acid precursor to the polyamideimide polymer within a certain range it is possible to obtain compositions with low toxicity solvents which are characterized by an optimal combination of the amount of polymer present in the composition and viscosity of the same and which render them highly suitable for coating applications.

### DISCLOSURE OF THE INVENTION

A first object of the invention is thus an aromatic polyamic/polyamideimide polymer [Polymer (PAI)] characterised by a molecular weight distribution M_{w}/Mₙ from 2.00 to 3.40. The molecular weight distribution M_{w}/Mₙ may be equal to or lower than 3.35, even equal to or lower than 3.30.

In an embodiment Polymer (PAI) has been obtained via an acid halide process.

A second object of the invention is a process for the preparation of Polymer (PAI) having a molecular weight distribution M_{w}/Mₙ from 2.00 to 3.40, said process comprising the polycondensation reaction between at least one aromatic polycarboxylic acid halide monomer and at least one aromatic diamine monomer in the presence of an excess of the aromatic polycarboxylic acid halide monomer with respect to the aromatic diamine monomer.

A third object of the invention is a composition comprising a low toxicity solvent and Polymer (PAI) having a molecular weight distribution M_{w}/Mₙ from 2.00 to 3.40. The composition preferably contains 15 to 40 wt % of Polymer (PAI) with respect to the total weight of the composition.

In an embodiment the composition has a viscosity of 1000 to 10000 cPoise.

A fourth object of the invention is a process for the manufacture of an article comprising the step of coating the composition on a substrate.

### DEFINITIONS

The use of parentheses before and after symbols or numbers identifying compounds, chemical formulae or parts of formulae has the mere purpose of better distinguishing those symbols or numbers from the rest of the text and hence said parentheses can also be omitted.

Any description, even though described in relation to a specific embodiment, is applicable to and interchangeable with other embodiments of the present invention.

Any recitation herein of numerical ranges by endpoints includes all numbers subsumed within the recited ranges as well as the endpoints of the range and equivalents.

According to a first object of the invention there is provided an aromatic polyamic acid/polyamideimide polymer [Polymer (PAI)] which comprises recurring units, more than 50 mol % of said recurring units comprise at least one aromatic ring and at least one amic acid group and/or imide group [recurring units (R_{PAI})] as defined below. Polymer (PAI) is characterized in that it has a molecular weight distribution, M_{w}/Mₙ, from 2.00 to 3.40. The molecular weight distribution M_{w}/Mₙ may be equal to or lower than 3.35, even equal to or lower than 3.30.

In some embodiments the molecular weight distribution M_{w}/Mₙ may be equal to or greater than 2.50, even equal to or greater than 2.80. The molecular weight distribution M_{w}/Mₙ may advantageously be from 2.50 to 3.40.

The number average molecular weight (Mₙ) of Polymer (PAI) is advantageously at least 1000, preferably at least 1500, more preferably at least 2000.

The number average molecular weight (Mₙ) of Polymer (PAI) is advantageously at most 20000, preferably at most 15000.

The molecular weight of Polymer (PAI) (M_{w} and Mₙ) may be determined using gel permeation chromatography (GPC) using a polystyrene standard as detailed hereafter.

Recurring units (R_{PAI}) are chosen from the group consisting of:

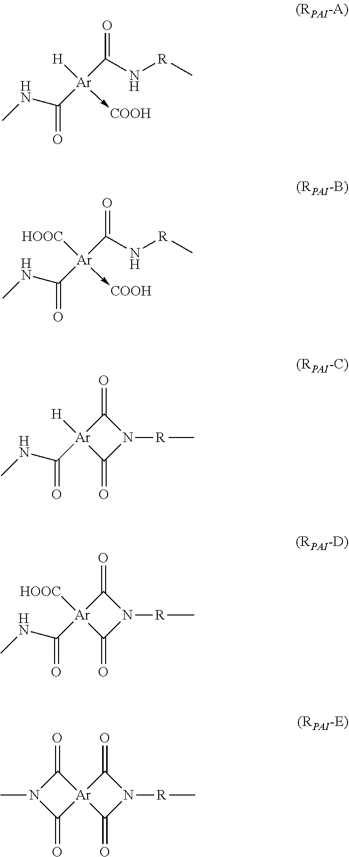

wherein:
the symbol → in each formula denotes isomerism so that, in any recurring unit within the aromatic polyamic acid structure, the groups to which the arrows point may exist as shown or in an interchanged position;
Ar is an aromatic tetravalent group, which may comprise one or more than one aromatic ring, and which are preferably selected from the group consisting of:

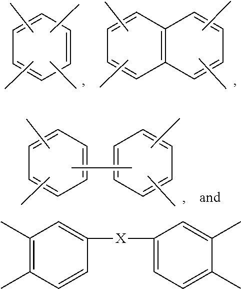

with X being selected from the group consisting of —O—, —C(O)—, —S—, —SO₂—, —CH₂—, —C(CF₃)₂—, —(CF₂)ₙ— with n=0, 1, 2, 3, 4 or 5;
R is an aromatic divalent group, which may comprise one or more than one aromatic ring, and which are preferably selected from the group consisting of:

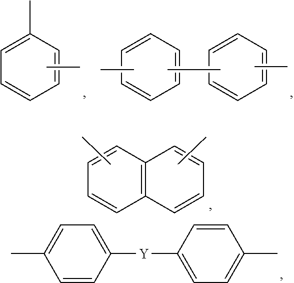

with Y being selected from the group consisting of —O—, —C(O)—, —S—, —SO₂—, —CH₂—, —C(CF₃)₂—, —(CF₂)ₙ— with n=0, 1, 2, 3, 4 or 5,

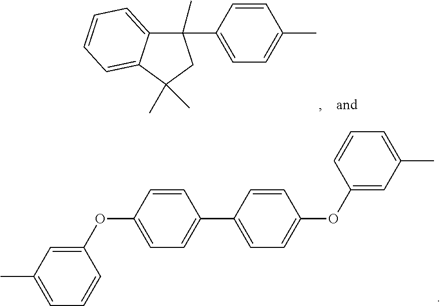

Recurring units (R_{PAI}) are preferably chosen from the group consisting of units (i), (ii) and (iii), as below detailed:

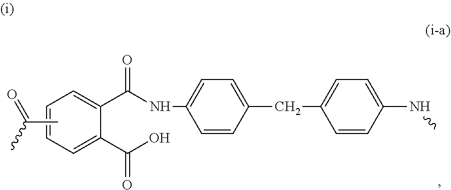

and/or the corresponding imide-group containing recurring unit:

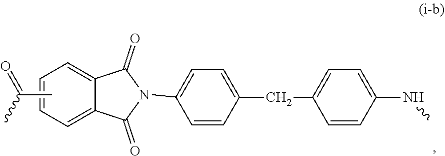

wherein the attachment of the two amide groups to the aromatic ring as shown in (i-a) will be understood to represent the 1,3 and the 1,4 polyamide-amic acid configurations,

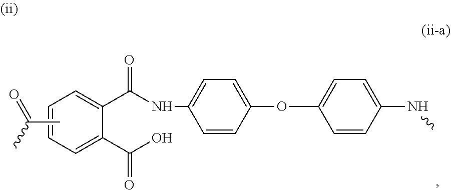

and/or the corresponding imide-group containing recurring unit:

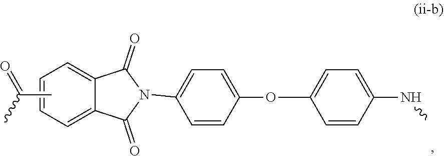

wherein the attachment of the two amide groups to the aromatic ring as shown in (ii-a) will be understood to represent the 1,3 and the 1,4 polyamide-amic acid configurations; and

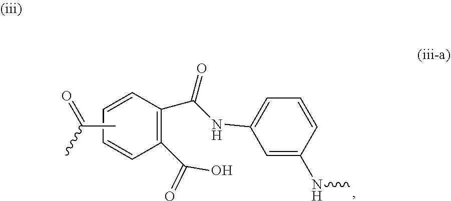

and/or the corresponding imide-group containing recurring unit:

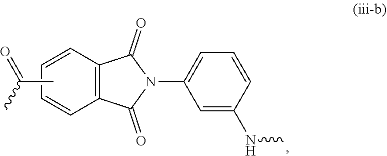

wherein the attachment of the two amide groups to the aromatic ring as shown in (iii-a) will be understood to represent the 1,3 and the 1,4 polyamide-amic acid configurations.

Recurring units (R_{PAI}) are preferably recurring units (i) or a mix of recurring units (ii) and (iii).

Preferably, Polymer (PAI) comprises more than 90 mol % of recurring units (R_{PAI}). Still more preferably, it contains no recurring unit other than recurring units (R_{PAI}).

Excellent results were obtained with Polymer (PAI) consisting of recurring units (i) or of a mix of recurring units (ii) and (iii).

The amount of recurring units comprising amic group can be determined by any suitable technique, such as, notably spectroscopic techniques or titration techniques which are well known to those of ordinary skills in the art.

When recurring units (R_{PAI}) are selected from those of formulae (R_{PAI}-A), (R_{PAI}-B), (R_{PAI}-C), (R_{PAI}-D), (R_{PAI}-E), as detailed above, the molar percentage of recurring units (R_{PAI}) comprising at least one amic acid group may be expressed as follows:

$$\frac{\begin{matrix}\{ [ ( {R}_{PAI} - A ) units ] + 2 \cdot [ ( {R}_{PAI} - B ) units ] + \\ [ ( {R}_{PAI} - D ) units ] \}\end{matrix}}{\begin{matrix}\{ [ ( {R}_{PAI} - A ) units ] + 2 \cdot [ ( {R}_{PAI} - B ) units ] + \\ [ ( {R}_{PAI} - C ) units ] + [ ( {R}_{PAI} - D ) units ] + \\ [ ( {R}_{PAI} - E ) units ] \}\end{matrix}}$$

where [(R_{PAI}-A) units], [(R_{PAI}-B) units], [(R_{PAI}-C) units], [(R_{PAI}-D) units], and [(R_{PAI}-E) units] denote, respectively molar concentration of the different recurring units (R_{PAI}) as above described.

In preferred embodiments, less than 25 mol %, even less than 20 mol %, still less than 15 mol % and preferably less than 10 mol % of recurring units (R_{PAI}) comprise at least one amic acid group.

The acid number (milligrams of KOH/gram) of Polymer (PAI) is advantageously less than 50, preferably less than 25.

The inherent viscosity of Polymer (PAI) is at least 0.30, preferably at least 0.50 dL/g and typically not exceeding 0.75 dL/g, when measured as a 0.5 wt % solution in NMP at 25° C.

Polymer (PAI) can be notably manufactured by a process including the polycondensation reaction between at least an aromatic polycarboxylic acid halide monomer and at least an aromatic diamine in the presence of an excess of the aromatic polycarboxylic acid halide monomer with respect to the aromatic diamine monomer.

The aromatic polycarboxylic acid halide monomer is typically present in excess of at least 5 mol % with respect to an equimolar concentration of the aromatic diamine monomer, even in an excess of at least 7 mol %. The aromatic polycarboxylic acid halide monomer is typically present in excess of at most 15 mol % with respect to an equimolar concentration of the aromatic diamine monomer. Good results were obtained with an excess of 10 to 15 mol % with respect to an equimolar concentration of the aromatic diamine monomer.

For the sake of clarity, the excess is calculated considering the total amount of all aromatic polycarboxylic acid halide monomers with respect to the total amount of all aromatic diamine monomers used in the polycondensation process.

The aromatic polycarboxylic acid halide monomer is chosen from the group consisting of terephthaloyl chloride, isophthaloyl chloride, phthaloyl chloride, and the acid halide derivatives of trimellitic anhydride. Preferably it is selected from the trimellitic anhydride monoacid halides. Among the trimellitic anhydride monoacid halides, trimellitic anhydride monoacid chloride is preferred.

In some embodiments, a dicarboxylic anhydride monomer may be used in combination with the polycarboxylic acid halide monomer. Suitable dicarboxylic anhydride monomers include pyromellitic anhydride, bis(3,4-dicarboxyphenyl)ether dianhydride, and trimellitic anhydride. When a dicarboxylic anhydride monomer is used in the process, the excess of the acid halide monomer with respect to the equimolar concentration of the aromatic diamine monomer is calculated taking into consideration the combined moles of the acide halide and the dicarboxylic anhydride monomers.

The aromatic diamine monomer is selected from the group consisting of 4,4′-diaminodiphenyl ether (ODA), p-phenylenediamine, (PDA), m-phenylenediamine (MPDA), diphenyl dimethyl methane diamine (DMMDA), 1,3-bis(3-aminophenoxy)benzene (BAPB), 4,4′-bisphenol A ether diamine (BAPP), 4,4′-bis(4-aminophenoxy) diphenylsulfone (BAPS), 4,4′-bis(4-aminophenoxy) diphenyl ether (BAPE), diamino diphenyl(methyl) ketone (DABP), 4,4′-diamino-triphenylamine (DATPA), 4,4′-diaminodiphenyl methane (MDA), diaminodiphenyl sulfone (DDS), 3,4′-diaminodiphenyl ether (3,4′-ODA), 3,3′-dimethyl-4,4′-diamino diphenyl methane (MDI), 4,4′-diamino-diphenoxy-1″,4″-benzene, 4,4′-diamino-diphenoxy-1″,3″-benzene, 3,3′-diamino-diphenoxy-1″,3″-benzene, 4,4′-diamino-diphenyl-4″,4-phenyl-isopropyl propane.

The aromatic diamine monomer is preferably selected from the group consisting of 4,4′-diaminodiphenyl ether (ODA), 4,4′-diaminodiphenyl methane (MDA), p-phenylenediamine, (PDA), and m-phenylenediamine (MPDA) and mixtures thereof.

The polycondensation reaction is advantageously carried out under substantially anhydrous conditions in a polar solvent and at a temperature below 150° C., employing a stoichiometric excess of the acid halide monomer.

A monofunctional reactant can be employed as an endcapping agent as known to the skilled in the art to control the molecular weight and to improve stability of the polymer.

Polymer (PAI) is advantageously isolated in solid form under mild conditions, preferably by being coagulated or precipitated from the polar reaction solvent by adding a miscible non-solvent, for example water, a lower alkyl alcohol or the like. Optionally, the solid resin may then be collected and thoroughly washed with water, and centrifuged or pressed to further reduce the water content of the solid without applying heat. Non-solvents other than water and lower alkyl alcohols are known and have been used in the art for precipitating Polymer (PAI) from solution including, for example, ethers, aromatic hydrocarbons, ketones and the like.

In a further aspect of the invention there is provided a composition comprising Polymer (PAI) and a non-toxic solvent, [solvent (S)]. The expression “non-toxic solvent” is used herein to refer to solvents which are not recognized as hazardous to human health.

Solvent (S) is generally selected from the group consisting of at least one of the following: N-butylpyrrolidone, N-acetylpyrrolidone, methyl-5-(dimethylamino)-2-methyl-5-oxopentanoate, dimethyldecanamide, 2-hydroxy-N,N-dimethylpropanamide, isosorbide dimethylether, 2-isobutyl-2-methyl-1,3-dioxolane-4-methanol, gamma-valerolactone, a mixture including ethyl lactate and an ethyl ester derived from soya bean oil or corn oil, dimethyl glutarate, dimethyl succinate, dimethyl adipate, mixtures of dimethyl glutarate, dimethyl succinate, dimethyl adipate and dimethyl 2-methylglutarate.

Preferably, solvent (S) is selected from the group consisting of at least one of the following: N-butylpyrrolidone, N-acetylpyrrolidone, methyl-5-(dimethylamino)-2-methyl-5-oxopentanoate, dimethyldecanamide, 2-hydroxy-N,N-dimethylpropanamide, isosorbide dimethylether, 2-isobutyl-2-methyl-1,3-dioxolane-4-methanol, cyclopentanone, gamma-valerolactone.

Most preferably, solvent (S) is selected from the group consisting of at least one of N-butylpyrrolidone and methyl-5-(dimethylamino)-2-methyl-5-oxopentanoate.

The composition of the invention typically comprises less than 5.0 wt %, less than 2.0 wt %, preferably less than 1.0 wt %, even less than 0.5 wt % and still less than 0.1 wt % of any solvent different from solvent (S).

The composition of the invention comprises advantageously at least 1 wt %, preferably at least 5 wt %, more preferably at least 10 wt % of Polymer (PAI) with respect to the total weight of the composition.

The composition of the invention comprises advantageously at most 55 wt %, preferably at most 50 wt %, more preferably at most 45 wt % of Polymer (PAI) with respect to the total weight of the composition.

Polymer compositions comprising 10 to 45 wt % of Polymer (PAI) with respect to the total weight of the composition gave very satisfactory results.

It has been unexpectedly found that compositions comprising Polymer (PAI) in an amount of 10 to 45 wt %, typically 15 to 40 wt %, possess a viscosity which is suitable for the use of said compositions in the manufacture of coatings.

Advantageously compositions comprising Polymer (PAI) in an amount of 10 to 45 wt % have viscosities measured at 25° C. of 500 to 10000 cPoise, typically from 1000 to 8000 cPoise which render them suitable for coating applications.

The composition may further comprise usual ingredients of coating compositions, notably: (i) dispersion agents; (ii) pigments like carbon black, silicates, metal oxides and sulfides; (iii) additives such as coating auxiliant or flow promoters; (iv) inorganic fillers like carbon fibers, glass fibers, metal sulfates, such as BaSO₄, CaSO₄, oxides such as Al₂O₃ and SiO₂, zeolites, mica, talc, kaolin; (v) organic fillers, preferably thermally stable polymers, like PTFE; (vi) film hardener, like silicate compounds, such as metal silicate, e.g. aluminium silicate and metal oxides, such as titanium dioxide; (vii) adhesion promoters, like colloidal silica and a phosphate compound, such as metal phosphate, e.g. Zn, Mₙ or Fe phosphate.

A further aspect of the invention is a process for the manufacture of an article comprising coating the inventive composition on a substrate. Coating may be performed by any suitable coating process, such as spin coating, slit spin coating, roll coating, die coating or curtain coating. The coating step is typically followed by a step wherein the applied composition is cured by pre-baking the resulting film at a temperature comprised between 12° and 400° C., preferably between 12° and 350° C., so as to allow the solvent to be volatilized.

The thickness of the coating may vary depending on the intended purpose. The thickness is preferably in the range of from 0.1 to 100 microns, preferably from 1 to 50 microns, more preferably from 5 to 20 microns, even more preferably the thickness is of about 10 microns.

In particular, compositions comprising Polymer (PAI) may be used for the coating of cookware, for the coating of oil and gas pipelines, for manufacturing aerospace parts and flexible electronic components, as dry film lubricant, as heat resistant ink, and for xerographic and can coating, as well as in other applications. The inventive compositions may find use in wire coating applications, such as enamels or base coats, in particular in the preparation of magnet wires or wires for e-motors in general.

In particular, Polymer PAI may be used in, but is not limited to, coating solutions that contain polytetrafluoroethylene (PTFE).

The inventive compositions may also be advantageously used in the preparation of NMP free battery binder formulations, in particular Li-ion battery binder formulations.

The invention will be now described with reference to the following examples, whose purpose is merely illustrative and not limitative of the present invention.

### Raw Materials

Trimellitic anhydride (TMA), Trimellitic acid chloride (TMAC), oxydianiline (ODA), m-phenylenediamine (MPDA) and N-methylpyrrolidone (NMP), are available from Sigma Aldrich. Methyl-5-(dimethylamino)-2-methyl-5-oxopentanoate is supplied under the trade name Rhodiasolv® Polarclean by Solvay. N-butylpyrrolidone (NBP) is available under the trade name Tamisolv® NxG from Eastman.

### Methods

### Solution Viscosity

Viscosity of polymers was measured with a Brookfield Viscometer in NMP at 25° C. at 23 wt % polymer concentration.

### Molecular Weight Determination Using GPC Method

GPC condition: Pump: Waters 515 solvent delivery system, or equivalent
Detector: Waters 2487 series UVNIS detector, or equivalent at 270 nm
Software: Waters Empower 3 Pro Gel Permeation Chromatography software or equivalent
Injector: Waters 717 Wisp Auto sampler or equivalent
Flow rate: 0.3 ml/min
UV detection: 270 nm
Column temperature: 45° C.
Column: Two PLgel 5 μm MiniMix-D, 250×4.6 mm Columns, Agilent, Part No. PL1510-5504; one PLgel 5 μm MiniMix-D Guard, 50×4.6 mm, Agilent, Part No. PL1510-1504
Injection: 10μ liter
Runtime: 30 minutes
Eluent: N,N-Dimethyl Acetamide/0.1M Lithium Bromide
Calibration standards: 10 Polystyrene Narrow calibration standards (Agilent Part No, PL2010-060). Of these 10 standards 8 could be separated ranging from Mp 364,000 to 2790 g/mol.
Concentration of calibration standard: 6 mg/mL
Calibration Curve: Type: Relative, Narrow calibration standard calibration
Fit: 3^{rd} order regression. Integration and calculation: Empower 3 Pro GPC software manufactured by Waters used to acquire data, calibration and molecular weight calculation. Peak integration start and end points are manually determined from significant difference on global baseline.
Sample Preparation: 24 mg of polymer was dissolved in 4 mL of eluent by heating up to 100° C. for 20 min with magnetic stir bar agitation. Once cooled, the solution was filtered using a 0.22-μm PTFE syringe filter and the resulting solution was passed through to GPC column according to the GPC conditions mentioned above.

### Example 1—Polymer PAI-1 Having M_{w}/Mₙ<3.40

ODA (0.201 moles) and MPDA (0.086 moles) were charged into a 4-neck jacketed round-bottom flask fitted with overhead mechanical stirrer. NMP (270 grams) was charged to the flask and the mixture was cooled to 10° C. with mild agitation under a nitrogen atmosphere. The flask was fitted with a heated addition funnel to which TMAC (0.316 moles) was charged and heated to a minimum of 100° C. The molten TMAC was added to the solution of diamine in NMP at a rate sufficient not to exceed 40° C. with vigorous agitation. Once the addition was complete, external heating was applied to maintain 35-40° C. for 2 hours. Additional NMP (50 g) was added and the reaction mixture discharged into a 500 mL beaker. The polymer solution was slowly added to water (4000 g) in a stainless steel high-shear mixer. The precipitated polymer was filtered and washed multiple times with water to remove residual solvent and acid by-product. The solid polymer was dried for at least 2 hours at 260° C. Residual NMP solvent was confirmed to be less than 0.1% by GC analysis.

### Comparative Example 1—Polymer PAI-2 Having M_{W}/M_{N}>3.40

ODA (0.263 moles) and MPDA (0.113 moles), and TMA (0.019) were charged into a 4-neck jacketed round-bottom flask fitted with overhead mechanical stirrer. NMP (290 grams) was charged to the flask and the mixture was cooled to 10° C. with mild agitation under a nitrogen atmosphere. The flask was fitted with a heated addition funnel to which TMAC (0.377 moles) was charged and heated to a minimum of 100° C. The molten TMAC was added to the solution of diamine in NMP at a rate sufficient not to exceed 40° C. with vigorous agitation. Once the addition was complete, external heating was applied to maintain 35-40° C. for 2 hours. Additional NMP (50 grams) was added and the reaction mixture discharged into a 500 mL beaker. The polymer solution was slowly added to water (4000 grams) in a stainless steel high-shear mixer. The precipitated polymer was filtered and washed multiple times with water to remove residual solvent and acid by-product. The solid polymer was dried for at least 2 hours at 260° C. Residual NMP solvent was confirmed to be less than 0.1% by GC analysis.

Table 1 summarizes the molecular weight properties of polymer PAI-1 and PAI-2.

TABLE 1

| Sample | Mₙ (g/mol) | M_{w} (g/mol) | M_{w}/Mₙ |
|---|---|---|---|
| PAI-1 | 9161 | 30018 | 3.28 |
| PAI-2 | 7684 | 27296 | 3.55 |

### Example 2—Compositions Comprising Polymer PAI

General procedure: a solution containing 23 wt % of polymer was prepared by heating a mixture of the polymer powder (4.74 g) and the selected solvent (S) (15.26 g) at 90° C. for 10 minutes.

As a comparison, a 25 wt % solution of polymer PAI-2 in NMP was also prepared by heating a mixture of polymer powder (5 g) and NMP (20 g) at 90° C. for 10 minutes.

The compositions and their properties are detailed in Table 2.

TABLE 2

| Run # | Polymer PAI | Solvent | Viscosity (cPs) |
|---|---|---|---|
| 1 | PAI-1 | Methyl-5-(dimethylamino)-2- | 8000 |
| | | methyl-5-oxopentanoate | |
| 2 | PAI-2 | Methyl-5-(dimethylamino)-2- | 18600 |
| | | methyl-5-oxopentanoate | |
| 3 | PAI-1 | NBP | 5500 |
| 4 | PAI-2 | NBP | 10300 |
| 5 | PAI-2 | NMP | 3000 |

The results in Table 2 show that compositions containing polymer PAI-1 having M_{w}/Mₙ of 3.28 have significantly lower viscosities than compositions containing the same amount of a PAI polymer with a M_{w}/Mₙ greater than 3.40 in the same solvent. This is surprising taking also into consideration the higher molecular weight of polymer PAI-1.

The comparison between the viscosity of the composition of run 5 and those of runs 2 and 4 show that PAI polymers with a M_{w}/Mₙ greater than 3.40 provide compositions in NMP having suitable viscosity for coating applications. These polymers however generate solutions which are too viscous for use when dissolved in solvents like methyl-5-(dimethylamino)-2-methyl-5-oxopentanoate or NBP. This issue can be successfully and surprisingly overcome by using the inventive PAI polymer.

1. An aromatic polyamic acid/polyamideimide polymer [Polymer (PAI)] which comprises recurring units, more than 50 mol % of said recurring units, [recurring units (R_{PAI})], are chosen from the group consisting of: 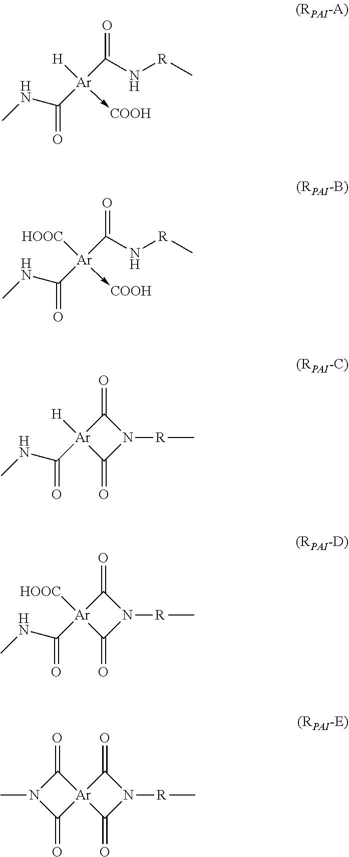
wherein:
the symbol → in each formula denotes isomerism so that, in any recurring unit within the aromatic polyamic acid structure, the groups to which the arrows point may exist as shown or in an interchanged position;
Ar is an aromatic tetravalent group, which may comprise one or more than one aromatic ring, and which is preferably selected from the group consisting of: 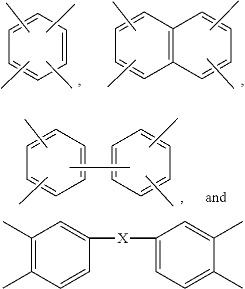
with X being selected from the group consisting of —O—, —C(O)—, —S—, —SO₂—, —CH₂—, —C(CF₃)₂—, —(CF₂)ₙ— with n=0, 1, 2, 3, 4 or 5;
R is an aromatic divalent group, which may comprise one or more than one aromatic ring, and which is preferably selected from the group consisting of: 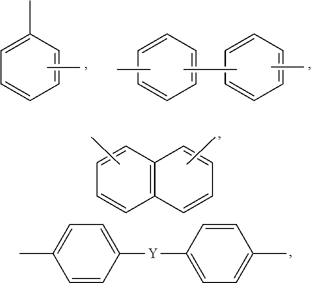
with Y being selected from the group consisting of —O—, —C(O)—, —S—, —SO₂—, —CH₂—, —C(CF₃)₂—, —(CF₂)ₙ— with n=0, 1, 2, 3, 4 or 5, 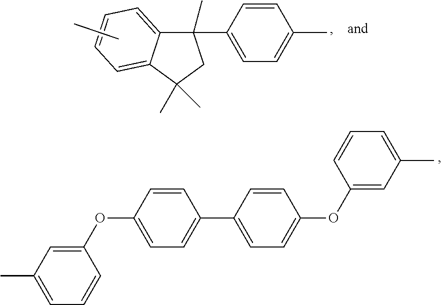
wherein said aromatic polyamic acid/polyamideimide polymer has a molecular weight distribution, M_{w}/Mₙ, from 2.00 to 3.40, and
wherein the recurring units (R_{PAI}) are chosen from the group consisting of units (i), (ii) and (iii): 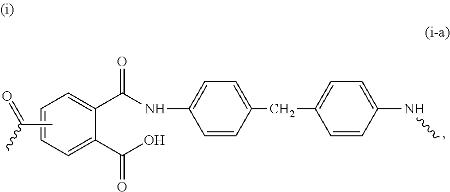
and/or the corresponding imide-group containing recurring unit: 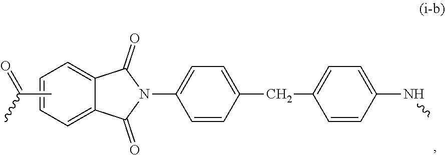
wherein the attachment of the two amide groups to the aromatic ring as shown in (i-a) will be understood to represent the 1,3 and the 1,4 polyamide-amic acid configurations; 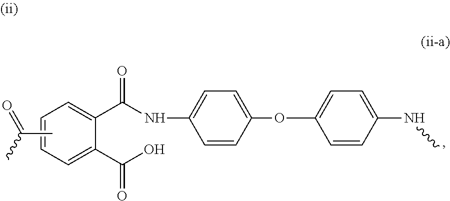
and/or the corresponding imide-group containing recurring unit: 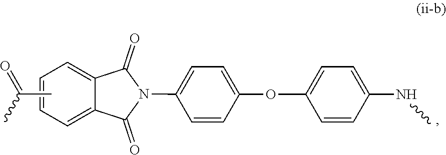
wherein the attachment of the two amide groups to the aromatic ring as shown in (ii-a) represent the 1,3 and the 1,4 polyamide-amic acid configurations; 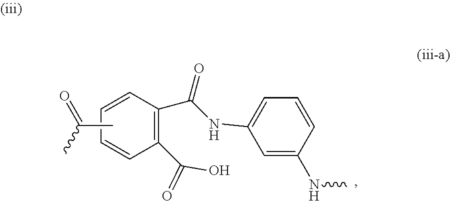
and/or the corresponding imide-group containing recurring unit: 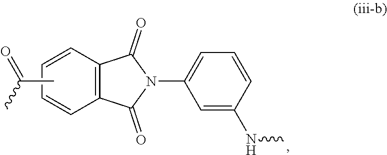
wherein the attachment of the two amide groups to the aromatic ring as shown in (iii-a) represent the 1,3 and the 1,4 polyamide-amic acid configurations; and 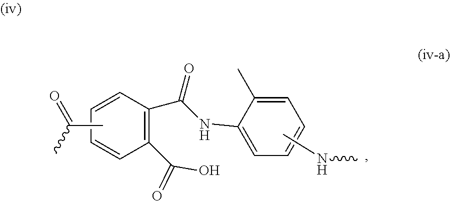
and/or the corresponding imide-group containing recurring unit: 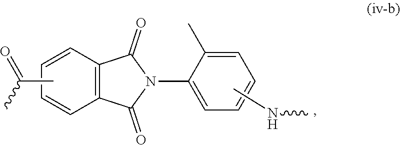
wherein the attachment of the two amide groups to the aromatic ring as shown in (iii-a) represent the 1,3 and the 1,4 polyamide-amic acid configurations.

2. (canceled)

3. The Polymer (PAI) of claim 1, in which the recurring units (R_{PAI}) are recurring units (i) or a mix of recurring units (ii) and (iii).

4. The Polymer (PAI) of claim 1, wherein the Polymer (PAI) comprises more than 90 mol % of recurring units (R_{PAI}).

5. The Polymer (PAI) of anyone of claim 1, wherein the Polymer (PAI) has an acid number of less than 50, measured as milligrams of KOH/gram of polymer.

6. The Polymer (PAI) of claim 1, wherein the Polymer (PAI) has a molecular weight distribution M_{w}/Mₙ from 2.50 to 3.40, preferably from 2.80 to 3.40.

7. A process for the manufacture of Polymer (PAI), the process comprising a polycondensation reaction between at least an aromatic polycarboxylic acid halide monomer and at least an aromatic diamine in the presence of an excess of the aromatic polycarboxylic acid halide monomer with respect to the aromatic diamine monomer.

8. The process of claim 7, wherein the aromatic polycarboxylic acid halide monomer is present in an excess of at least 5 mol % with respect to the equimolar concentration of the aromatic diamine monomer, preferably in an excess of 10 to 15 mol % with respect to the equimolar concentration of the aromatic diamine monomer.

9. A composition comprising a Polymer (PAI) and a non-toxic solvent, [solvent (S)].

10. The composition according to claim 9, wherein the solvent (S) is selected from the group consisting of at least one of the following: N-butylpyrrolidone, N-acetylpyrrolidone, methyl-5-(dimethylamino)-2-methyl-5-oxopentanoate, dimethyldecanamide, 1,3-Dimethyl-2-imidazolidinone (DMI), 3-methoxy-N,N-dimethylpropanamide, 2-hydroxy-N,N-dimethylpropanamide, isosorbide dimethylether, 2-isobutyl-2-methyl-1,3-dioxolane-4-methanol, gamma-valerolactone, a mixture including ethyl lactate and an ethyl ester derived from soya bean oil or corn oil, dimethyl glutarate, dimethyl succinate, dimethyl adipate, mixtures of dimethyl glutarate, dimethyl succinate, dimethyl adipate and dimethyl 2-methylglutarate.

11. The composition according to claim 9, wherein the solvent (S) is selected from the group consisting of at least one of N-butylpyrrolidone and methyl-5-(dimethylamino)-2-methyl-5-oxopentanoate.

12. The composition according to claim 9, wherein the composition comprises less than 5.0 wt %, less than 2.0 wt %, less than 1.0 wt % of any solvent different from the solvent (S).

13. The composition according to claim 9, further comprising 10 to 45 wt % of the Polymer (PAI) with respect to the total weight of the composition.

14. The process of claim 7, further comprising manufacturing an article comprising coating the Polymer (PAI) on a substrate.

15. The process of claim 14, further comprising the step of curing the Polymer (PAI) by heating at a temperature between 12° and 400° C.

16. The process of claim 7, further comprising forming an article comprising the Polymer (PAI).

17. The process of claim 16, wherein the article is a wire, a cookware article, a battery, a flexible electronic component, an oil or gas pipe.

18. (canceled)

19. The process of claim 7, wherein the Polymer (PAI) comprises recurring units, more than 50 mol % of said recurring units, [recurring units (R_{PAI})], are chosen from the group consisting of: 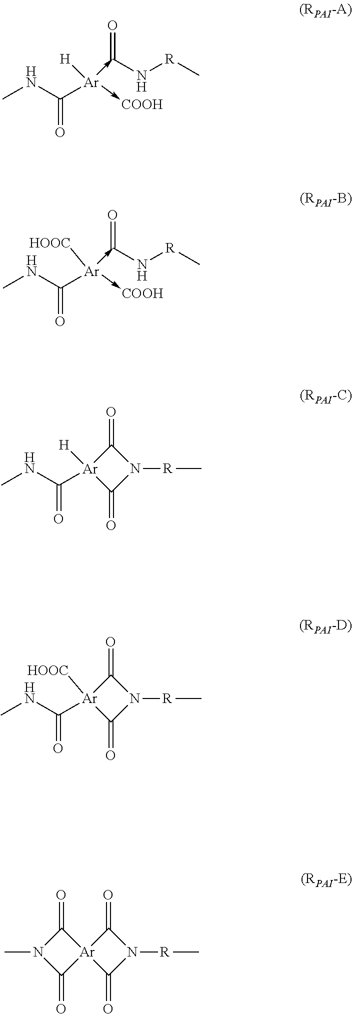
wherein:
the symbol → in each formula denotes isomerism so that, in any recurring unit within the aromatic polyamic acid structure, the groups to which the arrows point may exist as shown or in an interchanged position;
Ar is an aromatic tetravalent group, which may comprise one or more than one aromatic ring, and which is preferably selected from the group consisting of: 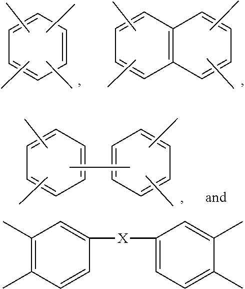
with X being selected from the group consisting of —O—, —C(O)—, —S—, —SO₂—, —CH₂—, —C(CF₃)₂—, —(CF₂)ₙ— with n=0, 1, 2, 3, 4 or 5;
R is an aromatic divalent group, which may comprise one or more than one aromatic ring, and which is preferably selected from the group consisting of: 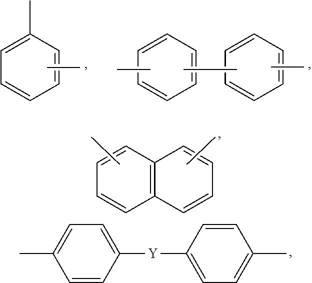
with Y being selected from the group consisting of —O—, —C(O)—, —S—, —SO₂—, —CH₂—, —C(CF₃)₂—, —(CF₂)ₙ— with n=0, 1, 2, 3, 4 or 5, 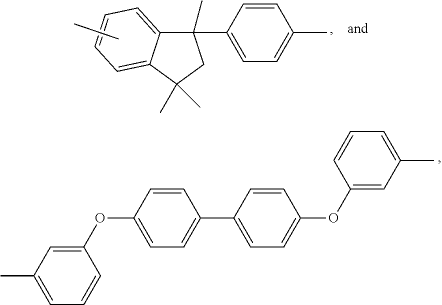
wherein said Polymer (PAI) has a molecular weight distribution, M_{w}/Mₙ from 2.00 to 3.40, and
wherein the recurring units (R_{PAI}) are chosen from the group consisting of units (i), (ii) and (iii): 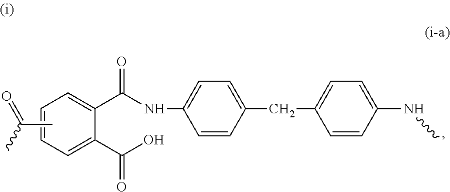
and/or the corresponding imide-group containing recurring unit: 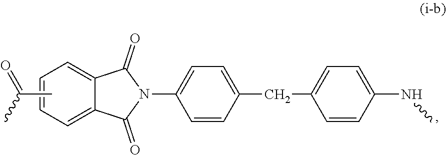
wherein the attachment of the two amide groups to the aromatic ring as shown in (i-a) will be understood to represent the 1,3 and the 1,4 polyamide-amic acid configurations; 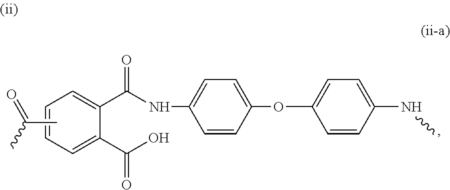
and/or the corresponding imide-group containing recurring unit: 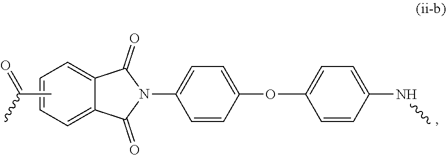
wherein the attachment of the two amide groups to the aromatic ring as shown in (ii-a) represent the 1,3 and the 1,4 polyamide-amic acid configurations; and 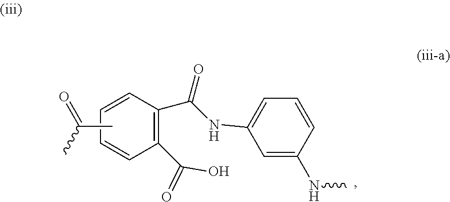
and/or the corresponding imide-group containing recurring unit: 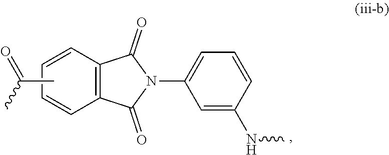
wherein the attachment of the two amide groups to the aromatic ring as shown in (iii-a) represent the 1,3 and the 1,4 polyamide-amic acid configurations.

20. The composition of claim 9, wherein the Polymer (PAI) comprises recurring units, more than 50 mol % of said recurring units, [recurring units (R_{PAI})], are chosen from the group consisting of: 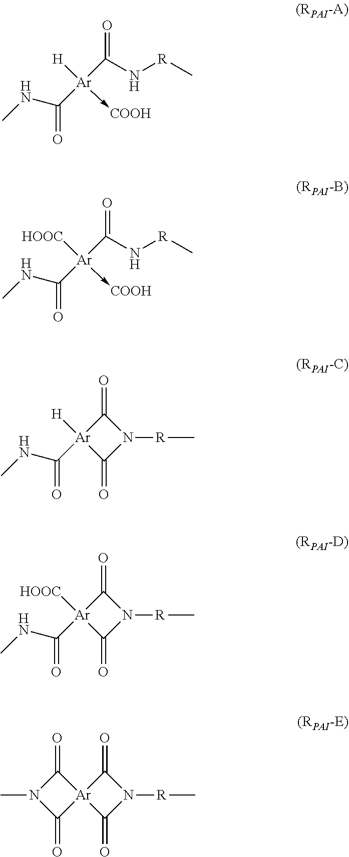
wherein:
the symbol → in each formula denotes isomerism so that, in any recurring unit within the aromatic polyamic acid structure, the groups to which the arrows point may exist as shown or in an interchanged position;
Ar is an aromatic tetravalent group, which may comprise one or more than one aromatic ring, and which is preferably selected from the group consisting of: 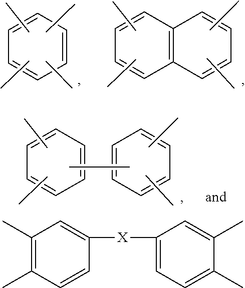
with X being selected from the group consisting of —O—, —C(O)—, —S—, —SO₂—, —CH₂—, —C(CF₃)₂—, —(CF₂)ₙ— with n=0, 1, 2, 3, 4 or 5;
R is an aromatic divalent group, which may comprise one or more than one aromatic ring, and which is preferably selected from the group consisting of: 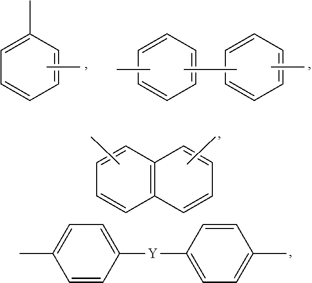
with Y being selected from the group consisting of —O—, —C(O)—, —S—, —SO₂—, —CH₂—, —C(CF₃)₂—, —(CF₂)ₙ— with n=0, 1, 2, 3, 4 or 5, 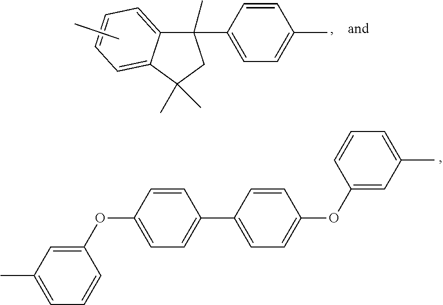
wherein said Polymer (PAI) has a molecular weight distribution, M_{w}/Mₙ from 2.00 to 3.40, and
wherein the recurring units (R_{PAI}) are chosen from the group consisting of units (i), (ii) and (iii): 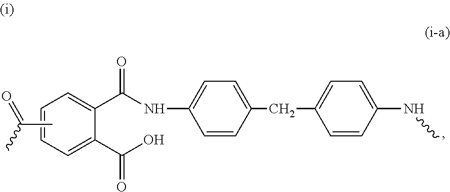
and/or the corresponding imide-group containing recurring unit: 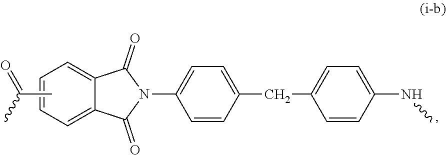
wherein the attachment of the two amide groups to the aromatic ring as shown in (i-a) will be understood to represent the 1,3 and the 1,4 polyamide-amic acid configurations; 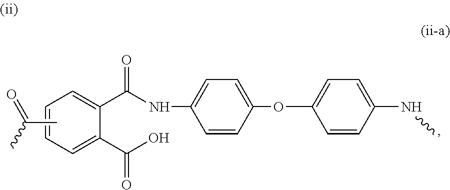
and/or the corresponding imide-group containing recurring unit: 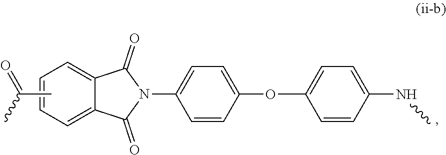
wherein the attachment of the two amide groups to the aromatic ring as shown in (ii-a) represent the 1,3 and the 1,4 polyamide-amic acid configurations; and 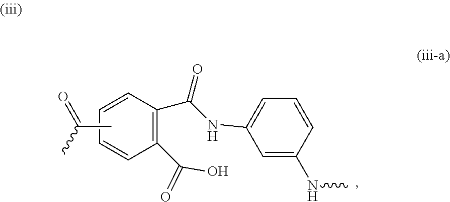
and/or the corresponding imide-group containing recurring unit: 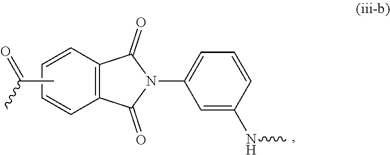
wherein the attachment of the two amide groups to the aromatic ring as shown in (iii-a) represent the 1,3 and the 1,4 polyamide-amic acid configurations.
